(19) United States
(12) Patent Application Publication
(10) Pub. No.: US 2019/0012575 A1
(43) Pub. Date: Jan. 10, 2019

(54) METHOD, APPARATUS AND SYSTEM FOR UPDATING DEEP LEARNING MODEL

(71) Applicant: BEIJING BAIDU NETCOM SCIENCE AND TECHNOLOGY CO., LTD., Beijing (CN)

(72) Inventors: Yuanhao XIAO, Beijing (CN); Faen ZHANG, Beijing (CN); Kai ZHOU, Beijing (CN); Qian WANG, Beijing (CN); Kun LIU, Beijing (CN); Dongze XU, Beijing (CN); Tianhan XU, Beijing (CN); Jiayuan SUN, Beijing (CN); Lan LIU, Beijing (CN)

(21) Appl. No.: 16/026,828

(22) Filed: Jul. 3, 2018

(30) Foreign Application Priority Data
Jul. 4, 2017 (CN) 201710539433.8

(51) Int. Cl. G06K 9/62; G06F 15/18; G06N 5/04

(52) U.S. Cl. CPC G06K 9/6256; G06N 5/04; G06F 15/18

(57) ABSTRACT

The present disclosure discloses a method, apparatus and system for updating a deep learning model. A specific embodiment of the method includes: receiving a new training data set sent by a client, the new training data set being detected by the client in a preset path; training a preset deep learning model based on the new training data set to obtain a trained prediction model; and updating the preset deep learning model to the prediction model so that the prediction model is used to perform a data prediction operation online. This embodiment realizes the docking with the training data set of the user and improves the update efficiency of the deep learning model.

### CROSS-REFERENCE TO RELATED APPLICATIONS

This application is related to and claims priority from Chinese Application No. 201710539433.8, filed on Jul. 4, 2017 and entitled “Method, Apparatus and System for Updating Deep Learning Model,” the entire disclosure of which is hereby incorporated by reference.

### TECHNICAL FIELD

The present disclosure relates to the field of computer technology, specifically to the field of Internet technology, and more specifically to a method, apparatus and system for updating a deep learning model.

### BACKGROUND

At present, the deep learning model needs to be continuously trained according to the update of training data sets to obtain a more accurate prediction model. The deep learning model is updated by using the prediction model, so that the prediction model is used to perform a data prediction operation online.

However, the existing training data set used to train the deep learning model is usually not the training data set provided by a user, and cannot be docked with the training data set of the user. In addition, the process of updating the deep learning model is usually manually triggered by the user, and the update efficiency of the deep learning model is usually low.

### SUMMARY

An objective of the present disclosure is to provide an improved method, apparatus and system for updating a deep learning model to solve the technical problem mentioned in the foregoing Background section.

In a first aspect, embodiments of the present disclosure provide a method for updating a deep learning model, the method including: receiving a new training data set sent by a client, the new training data set being detected by the client in a preset path; training a preset deep learning model based on the new training data set using a deep learning method to obtain a trained prediction model; and updating the preset deep learning model to the prediction model so that the prediction model is used to perform a data prediction operation online.

In some embodiments, the training a preset deep learning model based on the new training data set using a deep learning method, includes: selecting training data satisfying a preset condition from the new training data set, and generating a first training data set; and training the preset deep learning model based on first training data in the first training data set.

In some embodiments, after the generating a first training data set, the method further including: storing the first training data in the first training data set to a target training data set, wherein the target training data set is a preset training data set, and each time the preset deep learning model is trained, corresponding training data is acquired from the target training data set.

In some embodiments, the selecting training data satisfying a preset condition from the new training data set, and generating a first training data set, includes: performing a preset MapReduce task or a preset Spark task to select the training data satisfying the preset condition from the new training data set and generating the first training data set.

In some embodiments, the training the preset deep learning model based on first training data in the first training data set, includes: extracting feature information and a prediction result from the first training data in the first training data set; and training the preset deep learning model based on the extracted feature information and the prediction result corresponding to the extracted feature information.

In some embodiments, a data monitoring tool is pre-installed on the client, the new training data set is detected by the client by periodically inspecting a training data set in the preset path using the data monitoring tool, the data monitoring tool is installed on the client by a user to which the client belongs, and the client periodically inspects whether a new training data set exists in the preset path after the installed data monitoring tool is initiated and a training data synchronization instruction is sent by the user.

In a second aspect, the present disclosure provides an apparatus for updating a deep learning model, the apparatus including: a receiving unit, configured to receive a new training data set sent by a client, the new training data set being detected by the client in a preset path; a training unit, configured to train a preset deep learning model based on the new training data set to obtain a trained prediction model; and an updating unit, configured to update the preset deep learning model to the prediction model so that the prediction model is used to perform a data prediction operation online.

In some embodiments, the training unit includes: a generating subunit, configured to select training data satisfying a preset condition from the new training data set and generate a first training data set; and a training subunit, configured to train the preset deep learning model based on first training data in the first training data set.

In some embodiments, the apparatus further includes: a storing subunit, configured to store the first training data in the first training data set to a target training data set, wherein the target training data set is a preset training data set, and each time the preset deep learning model is trained, corresponding training data is acquired from the target training data set.

In some embodiments, the generating subunit is further configured to: perform a preset MapReduce task or a preset Spark task to select the training data satisfying the preset condition from the new training data set and generate the first training data set.

In some embodiments, the training subunit includes: an extracting module, configured to extract feature information and a prediction result from the first training data in the first training data set; and a training module, configured to train the preset deep learning model based on the extracted feature information and the prediction result corresponding to the extracted feature information.

In some embodiments, a data monitoring tool is pre-installed on the client, the new training data set is detected by the client by periodically inspecting a training data set in the preset path using the data monitoring tool, the data monitoring tool is installed on the client by a user to which the client belongs, and the client periodically inspects whether a new training data set exists in the preset path after the installed data monitoring tool is initiated and a training data synchronization instruction is sent by the user.

In a third aspect, the embodiments of the present disclosure provide a system for updating a deep learning model, the system including: a server and a client; the client is configured to periodically inspect whether a new training data set exists in a preset path, and if the new training data set exists in the preset path, send the new training data set to the server; and the server is configured to train a preset deep learning model based on the new training data set using a deep learning method to obtain a trained prediction model, and update the preset deep learning model to the prediction model so that the prediction model is used to perform a data prediction operation online.

In some embodiments, the training a preset deep learning model based on the new training data set using a deep learning method, includes: selecting training data satisfying a preset condition from the new training data set, and generating a first training data set; and training the preset deep learning model based on first training data in the first training data set.

In some embodiments, after the generating a first training data set, the server is further configured to: store the first training data in the first training data set to a target training data set, wherein the target training data set is a preset training data set, and each time the preset deep learning model is trained by the server, corresponding training data is acquired from the target training data set.

In some embodiments, the selecting training data satisfying a preset condition from the new training data set and generating a first training data set, includes: performing a preset MapReduce task or a preset Spark task to select the training data satisfying the preset condition from the new training data set and generating the first training data set.

In some embodiments, the training the preset deep learning model based on first training data in the first training data set, includes: extracting feature information and a prediction result from the first training data in the first training data set; and training the preset deep learning model based on the extracted feature information and the prediction result corresponding to the extracted feature information.

In some embodiments, a data monitoring tool is pre-installed on the client, the new training data set is detected by the client by periodically inspecting a training data set in the preset path using the data monitoring tool, the data monitoring tool is installed on the client by a user to which the client belongs, and the client periodically inspects whether a new training data set exists in the preset path after the installed data monitoring tool is initiated and a training data synchronization instruction is sent by the user.

In a fourth aspect, the embodiments of the present disclosure provide an electronic device, the electronic device including: one or more processors; a storage apparatus for storing one or more programs; the one or more programs, when executed by the one or more processors, causing the one or more processors to realize the method described in any embodiment in the first aspect.

In a fifth aspect, the embodiments of the present disclosure provide a computer-readable storage medium, storing a computer program thereon, the program, when executed by a processor, implementing the method described in any embodiment in the first aspect.

According to the method and apparatus for updating a deep learning model provided by the embodiments of the present disclosure, a new training data set sent by a client is received to facilitate training a preset deep learning model based on the new training data set to obtain a trained prediction model; and then the preset deep learning model is updated to the prediction model so that the prediction model is used to perform a data prediction operation online. The reception of the new training data set sent by the client is thus effectively utilized to realize the docking with the training data set of the user. After the new training data set is received, the preset deep learning model is automatically trained and updated based on the new training data set. Real-time updating of the deep learning model may be realized, and the updating efficiency of the deep learning model is improved.

According to the system for updating a deep learning model provided by the embodiments of the present disclosure, a client periodically inspects whether anew training data set exists in a preset path to facilitate sending the detected new training data set to the server, the server trains a preset deep learning model based on the received new training data set using a deep learning method to obtain a trained prediction model to facilitate updating the preset deep learning model to the prediction model, so that the prediction model is used to perform a data prediction operation online. The reception of the new training data set sent by the client to the server is thus effectively utilized to realize the docking with the training data set of the user. After receiving the new training data set, the server automatically trains and updates the preset deep learning model based on the new training data set. Real-time updating of the deep learning model may be realized, and the updating efficiency of the deep learning model is improved.

### BRIEF DESCRIPTION OF THE DRAWINGS

After reading detailed descriptions of non-limiting embodiments with reference to the following accompanying drawings, other features, objectives and advantages of the present disclosure will be more apparent:

FIG. 1 is an architectural diagram of an exemplary system in which the present disclosure may be implemented;

FIG. 2 is a flowchart of an embodiment of a method for updating a deep learning model according to the present disclosure;

FIG. 3 is a schematic diagram of an application scenario of the method for updating a deep learning model according to the present disclosure;

FIG. 4 is a flowchart of another embodiment of the method for updating a deep learning model according to the present disclosure;

FIG. 5 is a schematic structural diagram of an embodiment of an apparatus for updating a deep learning model according to the present disclosure;

FIG. 6 is a schematic structural diagram of an embodiment of a system for updating a deep learning model according to the present disclosure; and

FIG. 7 is a schematic structural diagram of a computer system adapted to implement an electronic device of the embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

FIG. 1 shows an exemplary architecture of a system 100 which may be used by a method for updating a deep learning model or an apparatus for updating a deep learning model according to the embodiments of the present disclosure.

As shown in FIG. 1, the system architecture 100 may include a client 101, a network 102 and a server 103. The network 102 serves as a medium providing a communication link between the client 101 and the server 103. The network 102 may include various types of connections, such as wired or wireless transmission links, or optical fibers.

The client 101 may be a server providing various services, such as a server for saving training data sets of the user.

The client 101 may further periodically inspect whether a new training data set is received, and send the detected new training data set to the server 103.

The server 103 may be a server providing various services, for example, receiving a new training data set from the client 101, and processing the new training data set.

It should be noted that the method for updating a deep learning model according to the embodiments of the present disclosure is generally executed by the server 103. Accordingly, an apparatus for updating a deep learning model is generally installed on the server 103.

It should be appreciated that the numbers of the clients, the networks and the servers in FIG. 1 are merely illustrative. Any number of clients, networks and servers may be provided based on the actual requirements.

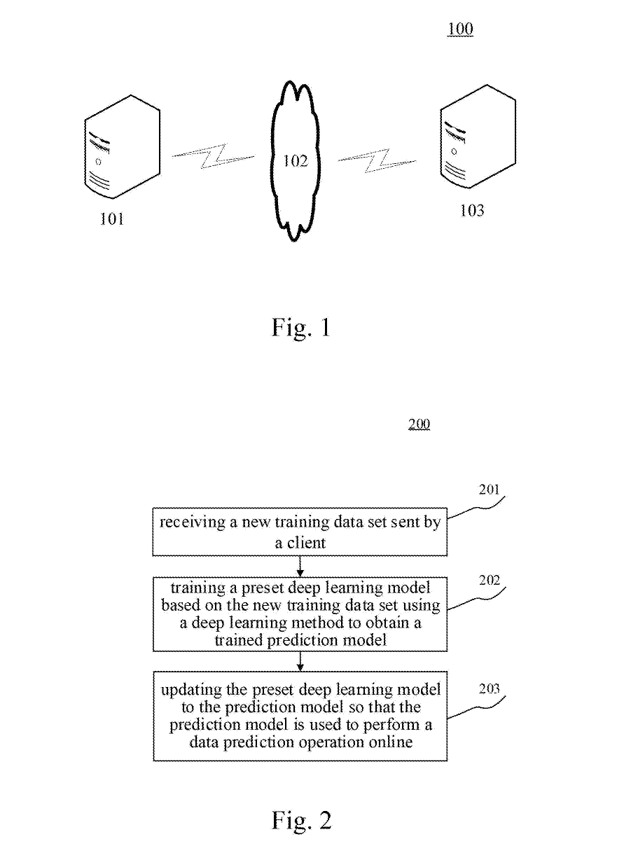

Further referring to FIG. 2, a flow 200 of an embodiment of the method for updating a deep learning model according to the present disclosure is shown. The method for updating a deep learning model includes the following steps.

Step 201, receiving a new training data set sent by a client.

In the present embodiment, an electronic device (e.g., the server 103 as shown in FIG. 1) on which the method for updating a deep learning model is performed may receive a new training data set (e.g., a training data set that has not been used for model training) sent by a client (e.g., the client 101 as shown in FIG. 1) through a wired connection or a wireless connection. Here, the new training data set may be detected by the client in a preset path. The preset path may be a path created in advance on the client by a user to which the client belongs, for storing the training data set of the user. The client may be used to periodically inspect (e.g., every 6 hours or a day) whether a new training data set exists in the preset path.

Step 202, training a preset deep learning model based on the new training data set using a deep learning method to obtain a trained prediction model.

In the present embodiment, after receiving the new training data set sent by the client, the electronic device may train the preset deep learning model based on the new training data set using the deep learning method to obtain the trained prediction model. Here, Deep Learning is a branch of machine learning. Deep Learning is an algorithm that attempts to perform high-level abstraction on data using multiple processing layers that contain complex structures or consist of multiple nonlinear transformations. In addition, the preset deep learning model may be a deep learning model created in advance by the user. The deep learning model usually needs to be continuously trained according to the update of training data sets to obtain a more accurate prediction model. It should be noted that, the user may upload a model training code written using the deep learning method to the electronic device in advance. The electronic device may train the preset deep learning model based on the new training data set by running the model training code to obtain the trained prediction model.

Step 203, updating the preset deep learning model to the prediction model so that the prediction model is used to perform a data prediction operation online.

In the present embodiment, after obtaining the trained prediction model, the electronic device may update the preset deep learning model to the prediction model, so that the prediction model is used to perform a data prediction operation online. For example, the electronic device may receive a prediction data set, perform feature information extraction on prediction data in the prediction data set, and input the extracted feature information into the prediction model to obtain a prediction result (e.g., a category of the prediction data corresponding to the feature information.)

In some alternative implementations of the present embodiment, before updating the preset deep learning model to the prediction model, the electronic device may save the preset deep learning model for later use. The preset deep learning model may be acquired when needed.

In some alternative implementations of the present embodiment, the electronic device may train the preset deep learning model based on each training data in the new training data set. If the electronic device train the preset deep learning model based on the each training data in the new training data set, when receiving the new training data set, the electronic device may store the each training data in the new training data set to a target training data set. Here, the target training data set maybe a preset training data set (for example, may be a training data set created by the user in advance through the client on the server), and each time the preset deep learning model is trained by the electronic device, corresponding training data maybe acquired from the target training data set.

In some alternative implementations of the present embodiment, the client may be pre-installed with a data monitoring tool, and the new training data set received by the electronic device may be detected by the client by periodically inspecting training data in the preset path using the data monitoring tool. Here, the data monitoring tool may be installed on the client by the user. The client may periodically inspect whether a new training data set exists in the preset path after the installed data monitoring tool is initiated and a training data synchronization instruction is sent by the user (i.e., sending the training data synchronization instruction to the electronic device.) It should be noted that the electronic device may provide the user with the data monitoring tool, and the user may download the data monitoring tool from the electronic device and install the downloaded data monitoring tool on the client.

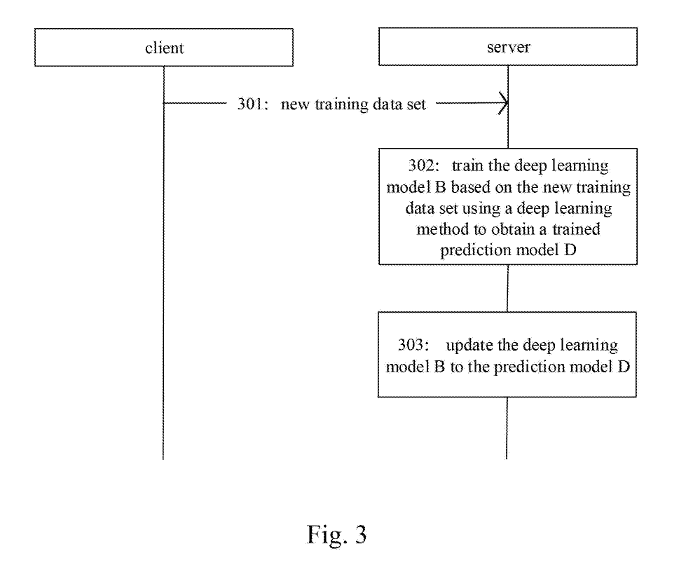

Further referring to FIG. 3, FIG. 3 is a schematic diagram of an application scenario of the method for updating a deep learning model according to the present embodiment. In the application scenario of FIG. 3, user A may create a deep learning model B on the server through a client in advance for performing an online data prediction operation. The user A may also create a path such as “D:\training data set” in advance for storing the training data set on all its clients, so that the user A may keep storing new training data sets to the path “D:\training data set”. Here, the training data sets in the path “D:\training data set” are used to train the deep learning model B. The user A may also set a thread C having hardware and software resources on the above client for periodically inspecting whether a new training data set exists in the path “D:\training data set”. Here, when the client detects a new training data set in the path “D:\training data set” using the thread C, as indicated by a reference numeral 301, the client may send the new training data set to the server. Then, as indicated by a reference numeral 302, the server may train the deep learning model B based on the new training data set using a deep learning method to obtain a trained prediction model D. Finally, as indicated by a reference numeral 303, the server may update the deep learning model B to the prediction model D so that the prediction model D is used to perform a data prediction operation online.

The method provided by the above embodiment of the present disclosure realizes the docking with the training data set of the user by receiving the new training data set sent by the client. After the new training data set is received, the preset deep learning model is automatically trained and updated based on the new training data set. Real-time updating of the deep learning model may be realized, and the updating efficiency of the deep learning model is improved.

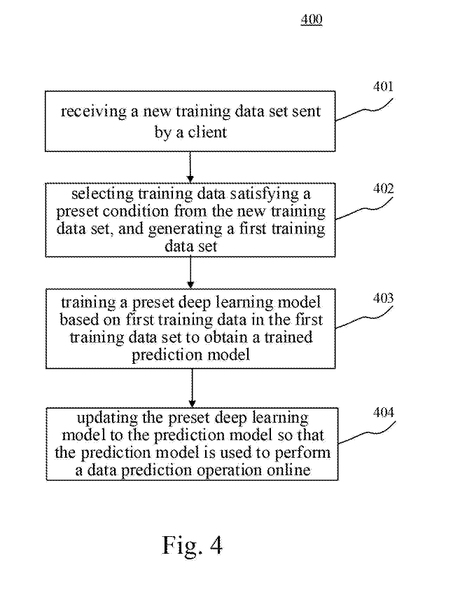

Further referring to FIG. 4, a flow 400 of another embodiment of the method for updating a deep learning model is shown. The flow 400 of the method for updating a deep learning model includes the following steps.

Step 401, receiving a new training data set sent by a client.

In the present embodiment, an electronic device (e.g., the server 103 as shown in FIG. 1) on which the method for updating a deep learning model is performed may receive a new training data set (e.g., a training data set that has not been used for model training) sent by a client (e.g., the client 101 as shown in FIG. 1) through a wired connection or a wireless connection. Here, the new training data set may be detected by the client in a preset path. The preset path may be a path created in advance on the client by a user to which the client belongs, for storing the training data set of the user. The client may be used to periodically inspect (e.g., every 6 hours or a day) whether a new training data set exists in the preset path.

Step 402, selecting training data satisfying a preset condition from the new training data set, and generating a first training data set.

In the present embodiment, after receiving the new training data set sent by the client, the electronic device may select training data satisfying a preset condition from the new training data set to generate a first training data set. Here, at least part of the training data in the new training data set may include feature information and a prediction result. The preset condition may be, for example, not including a prediction result or feature information. It should be noted that the preset condition maybe preset by the user, and the present embodiment does not limit the content in any aspect.

Step 403, training a preset deep learning model based on first training data in the first training data set to obtain a trained prediction model.

In the present embodiment, after generating the first training data set, the electronic device may train the preset deep learning model based on first training data in the first training data set to obtain a trained prediction model. As an example, the electronic device may first extract feature information and a prediction result from the first training data in the first training data set, and then train the preset deep learning model based on the extracted feature information and the prediction result corresponding to the feature information. For example, the feature information is used as an input of the preset deep learning model, and the prediction result corresponding to the feature information is used as an output of the preset deep learning model to implement training of the preset deep learning model.

Step 404, updating the preset deep learning model to the prediction model so that the prediction model is used to perform a data prediction operation online.

In the present embodiment, after obtaining the trained prediction model, the electronic device may update the preset deep learning model to the prediction model, so that the prediction model is used to perform a data prediction operation online.

In some alternative implementations of the present embodiment, after generating the first training data set, the electronic device may store the first training data in the first training data set to a target training data set. Here, the target training data set may be a preset training data set (for example, a training data set created by the user on the electronic device in advance through the client), and each time the preset deep learning model is trained by the electronic device, corresponding training data may be acquired from the target training data set.

In some alternative implementations of the present embodiment, the electronic device may further perform a preset MapReduce task or a preset Spark task to select the training data satisfying the preset condition from the new training data set and generate the first training data set. Here, the preset MapReduce task or the preset Spark task may be a task submitted by the user in advance to the electronic device. It should be noted that MapReduce is a programming model that is commonly used for parallel computing of large-scale data sets. The concepts “Map” and “Reduce”, and their main ideas, are usually borrowed from a functional programming language and borrowed from a vector programming language. It greatly facilitates programmers without distributed parallel programming skills to run their programs on distributed systems. Spark is a cluster computing platform designed for speed and the general purpose. From the speed perspective, Spark inherits the popular MapReduce models and may support multiple types of calculations more effectively, such as interactive query and stream processing.

As may be seen from FIG. 4, compared with the embodiment corresponding to FIG. 2, the flow 400 of the method for updating a deep learning model in this embodiment highlights the step of generating the first training data set and the step of training the preset deep learning model based on the first training data in the first training data set. Thus, the solution described in the present embodiment may acquire the training data required for true training, thereby improving the training efficiency of the deep learning model and further improving the prediction accuracy of the trained prediction model. Since the preset deep learning model is not trained based on all the training data in the received new training data set, training time may be saved, and the update efficiency of the deep learning model may be further improved.

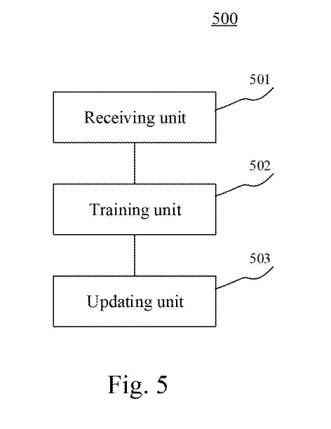

Further referring to FIG. 5, as an implementation to the method shown in the above figures, the present disclosure provides an embodiment of an apparatus for updating a deep learning model. The apparatus embodiment corresponds to the method embodiment shown in FIG. 2, and the apparatus may be specifically applied to various electronic devices.

As shown in FIG. 5, the apparatus 500 for updating a deep learning model shown in this embodiment includes: a receiving unit 501, a training unit 502, and an updating unit 503. The receiving unit 501 is configured to receive a new training data set sent by a client, the new training data set being detected by the client in a preset path. The training unit 502 is configured to train a preset deep learning model based on the new training data set to obtain a trained prediction model. The updating unit 503 is configured to update the preset deep learning model to the prediction model so that the prediction model is used to perform a data prediction operation online.

In the present embodiment, in the apparatus 500 for updating a deep learning model, the specific processing of the receiving unit 501, the training unit 502, and the updating unit 503 and the technical effects thereof may refer to the related descriptions of step 201, step 202, and step 203 in the corresponding embodiment of FIG. 2 respectively, and detailed descriptions thereof will be omitted.

In some alternative implementations of the present embodiment, the training unit 502 may include: a generating subunit (not shown in the figure), configured to select training data satisfying a preset condition from the new training data set and generate a first training data set; and a training subunit (not shown in the figure), configured to train the preset deep learning model based on first training data in the first training data set.

In some alternative implementations of the present embodiment, the apparatus 500 may further include: a storing subunit (not shown in the figure), configured to store the first training data in the first training data set to a target training data set. The target training data set is a preset training data set, and each time the preset deep learning model is trained, corresponding training data is acquired from the target training data set.

In some alternative implementations of the present embodiment, the generating subunit may be further configured to: perform a preset MapReduce task or a preset Spark task to select the training data satisfying the preset condition from the new training data set and generate the first training data set.

In some alternative implementations of the present embodiment, the training subunit may include: an extracting module (not shown in the figure), configured to extract feature information and a prediction result from the first training data in the first training data set; and a training module (not shown in the figure), configured to train the preset deep learning model based on the extracted feature information and the prediction result corresponding to the extracted feature information.

In some alternative implementations of the present embodiment, a data monitoring tool may be pre-installed on the client, the new training data set may be detected by the client by periodically inspecting a training data set in the preset path using the data monitoring tool, the data monitoring tool may be installed on the client by a user to which the client belongs, and the client may periodically inspect whether a new training data set exists in the preset path after the installed data monitoring tool is initiated and a training data synchronization instruction is sent by the user.

The apparatus provided by the above embodiment of the present disclosure realizes the docking with the training data set of the user by receiving the new training data set sent by the client. After the new training data set is received, the preset deep learning model is automatically trained and updated based on the new training data set. Real-time updating of the deep learning model may be realized, and the updating efficiency of the deep learning model is improved.

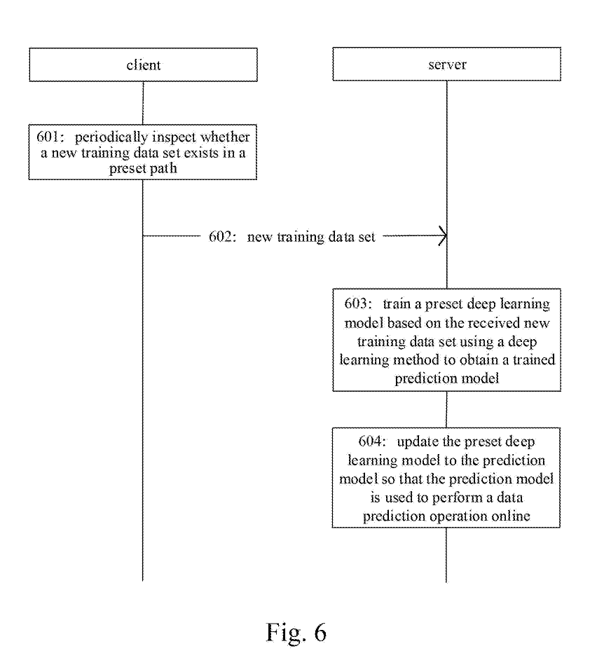

Further referring to FIG. 6, a timing diagram of an embodiment of a system for updating a deep learning model according to the present disclosure is illustrated.

The system for updating a deep learning model of the present embodiment may include: a server and a client. The client is configured to periodically inspect whether a new training data set exists in a preset path, and if so, send the new training data set to the server. The server is configured to train a preset deep learning model based on the new training data set using a deep learning method to obtain a trained prediction model, and update the preset deep learning model to the prediction model so that the prediction model is used to perform a data prediction operation online.

As shown in FIG. 6, in step 601, the client periodically inspects whether a new training data set exists in a preset path.

In this embodiment, the client (e.g., the client 101 as shown in FIG. 1) may periodically (e.g., every 6 hours or a day) detect whether a new training data set (e.g., a training data set that has not been used for model training) exists in the preset path. Here, the preset path may be a path created in advance on the client by a user to which the client belongs, for storing the training data set of the user.

In step 602, in response to detecting that a new training data set exists in the preset path, the client sends the detected new training data set to the server.

In this embodiment, in response to the client detecting that a new training data set exists in the preset path, the client may send the detected new training data set to the server through a wired connection or a wireless connection.

In step 603, the server trains a preset deep learning model based on the received new training data set using a deep learning method to obtain a trained prediction model.

In step 604, the server updates the preset deep learning model to the prediction model so that the prediction model is used to perform a data prediction operation online.

In this embodiment, for the explanations of step 603 and step 604, reference maybe made to the related descriptions to step 202 and step 203 in the embodiment shown in FIG. 2, respectively, and details description thereof will be omitted.

The system provided by the above embodiment of the present disclosure realizes the docking with the training data set of the user through the server receiving the new training data set sent by the client. After receiving the new training data set, the server automatically trains and updates the preset deep learning model based on the new training data set. Real-time updating of the deep learning model may be realized, and the updating efficiency of the deep learning model is improved.

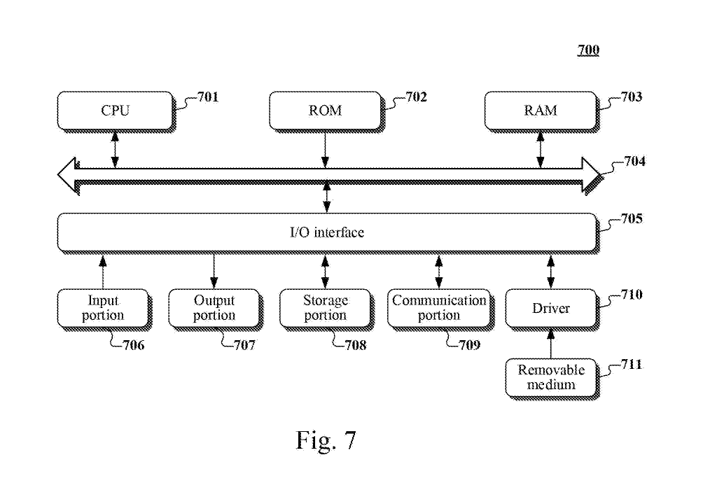

Referring to FIG. 7, a schematic structural diagram of a computer system 700 adapted to implement an electronic device of the embodiments of the present disclosure is shown. The electronic device shown in FIG. 7 is merely an example, and should not bring any limitations to the functions and the scope of use of the embodiments of the present disclosure.

As shown in FIG. 7, the computer system 700 includes a central processing unit (CPU) 701, which may execute various appropriate actions and processes in accordance with a program stored in a read-only memory (ROM) 702 or a program loaded into a random access memory (RAM) 703 from a storage portion 708. The RAM 703 also stores various programs and data required by operations of the system 700. The CPU 701, the ROM 702 and the RAM 703 are connected to each other through a bus 704. An input/output (I/O) interface 705 is also connected to the bus 704.

The following components are connected to the I/O interface 705: an input portion 706 including a keyboard, a mouse etc.; an output portion 707 comprising a cathode ray tube (CRT), a liquid crystal display device (LCD), a speaker etc.; a storage portion 708 including a hard disk and the like; and a communication portion 709 comprising a network interface card, such as a LAN card and a modem. The communication portion 709 performs communication processes via a network, such as the Internet. A driver 710 is also connected to the I/O interface 705 as required. A removable medium 711, such as a magnetic disk, an optical disk, a magneto-optical disk, and a semiconductor memory, may be installed on the driver 710, to facilitate the retrieval of a computer program from the removable medium 711, and the installation thereof on the storage portion 708 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 709, and/or may be installed from the removable media 711. The computer program, when executed by the central processing unit (CPU) 701, implements the above mentioned functionalities as defined by the methods of the present disclosure.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in the embodiments of the present disclosure may be implemented by means of software or hardware. The described units may also be provided in a processor, for example, described as: a processor, comprising a receiving unit, a training unit, and an updating unit, where the names of these units do not in some cases constitute a limitation to such units or modules themselves. For example, the receiving unit may also be described as “a unit for receiving a new training data set sent by a client”.

In another aspect, the present disclosure further provides a computer-readable storage medium. The computer-readable storage medium may be the computer storage medium included in the electronic device in the above described embodiments, or a stand-alone computer-readable storage medium not assembled into the electronic device. The computer-readable storage medium stores one or more programs. The one or more programs, when executed by a device, cause the device to: receiving a new training data set sent by a client, the new training data set being detected by the client in a preset path; training a preset deep learning model based on the new training data set using a deep learning method to obtain a trained prediction model; and updating the preset deep learning model to the prediction model so that the prediction model is used to perform a data prediction operation online.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for updating a deep learning model, the method comprising:
receiving a new training data set sent by a client, the new training data set being detected by the client in a preset path;
training a preset deep learning model based on the new training data set using a deep learning method to obtain a trained prediction model; and
updating the preset deep learning model to the prediction model so that the prediction model is used to perform a data prediction operation online.

2. The method according to claim 1, wherein the training a preset deep learning model based on the new training data set using a deep learning method, comprises:
selecting training data satisfying a preset condition from the new training data set, and generating a first training data set; and
training the preset deep learning model based on first training data in the first training data set.

3. The method according to claim 2, after the generating a first training data set, the method further comprising:
storing the first training data in the first training data set to a target training data set, wherein the target training data set is a preset training data set, and each time the preset deep learning model is trained, corresponding training data is acquired from the target training data set.

4. The method according to claim 2, wherein the selecting training data satisfying a preset condition from the new training data set, and generating a first training data set, comprises:
performing a preset MapReduce task or a preset Spark task to select the training data satisfying the preset condition from the new training data set and generating the first training data set.

5. The method according to claim 2, wherein the training the preset deep learning model based on first training data in the first training data set, comprises:
extracting feature information and a prediction result from the first training data in the first training data set; and
training the preset deep learning model based on the extracted feature information and the prediction result corresponding to the extracted feature information.

6. The method according to claim 1, wherein a data monitoring tool is pre-installed on the client, the new training data set is detected by the client by periodically inspecting a training data set in the preset path using the data monitoring tool, the data monitoring tool is installed on the client by a user to which the client belongs, and the client periodically inspects whether a new training data set exists in the preset path after the installed data monitoring tool is initiated and a training data synchronization instruction is sent by the user.

7. An apparatus for updating a deep learning model, the apparatus comprising:
at least one processor; and
a memory storing instructions, the instructions when executed by the at least one processor, cause the at least one processor to perform operations, the operations comprising:
receiving a new training data set sent by a client, the new training data set being detected by the client in a preset path;
training a preset deep learning model based on the new training data set to obtain a trained prediction model; and
updating the preset deep learning model to the prediction model so that the prediction model is used to perform a data prediction operation online.

8. The apparatus according to claim 7, wherein the training a preset deep learning model based on the new training data set using a deep learning method, comprises:
selecting training data satisfying a preset condition from the new training data set and generate a first training data set; and
training the preset deep learning model based on first training data in the first training data set.

9. The apparatus according to claim 8, the operations further comprising:
storing the first training data in the first training data set to a target training data set, wherein the target training data set is a preset training data set, and each time the preset deep learning model is trained, corresponding training data is acquired from the target training data set.

10. The apparatus according to claim 8, wherein the selecting training data satisfying a preset condition from the new training data set, and generating a first training data set, comprises:
performing a preset MapReduce task or a preset Spark task to select the training data satisfying the preset condition from the new training data set and generate the first training data set.

11. The apparatus according to claim 8, wherein the training the preset deep learning model based on first training data in the first training data set, comprises:
extracting feature information and a prediction result from the first training data in the first training data set; and
training the preset deep learning model based on the extracted feature information and the prediction result corresponding to the extracted feature information.

12. The apparatus according to claim 7, wherein a data monitoring tool is pre-installed on the client, the new training data set is detected by the client by periodically inspecting a training data set in the preset path using the data monitoring tool, the data monitoring tool is installed on the client by a user to which the client belongs, and the client periodically inspects whether a new training data set exists in the preset path after the installed data monitoring tool is initiated and a training data synchronization instruction is sent by the user.

13. A non-transitory computer storage medium storing a computer program, the computer program when executed by one or more processors, causes the one or more processors to perform operations, the operations comprising:
receiving a new training data set sent by a client, the new training data set being detected by the client in a preset path;
training a preset deep learning model based on the new training data set using a deep learning method to obtain a trained prediction model; and
updating the preset deep learning model to the prediction model so that the prediction model is used to perform a data prediction operation online.
